(19) United States
(12) Patent Application Publication
(10) Pub. No.: US 2025/0328973 A1
(43) Pub. Date: Oct. 23, 2025

(54) Systems and Methods to Identify Commercialization and Partnership Potential for Research Institutions

(71) Applicant: Northwestern University, Evanston, IL (US)

(72) Inventors: Dashun Wang, Evanston, IL (US); Benjamin F. Jones, Evanston, IL (US); Yifan Qian, Evanston, IL (US)

(21) Appl. No.: 19/122,087

(22) PCT Filed: Nov. 3, 2023
(86) PCT No.: PCT/US23/78679

§ 371 Date: Apr. 17, 2025

Related U.S. Application Data
(60) Provisional application No. 63/422,079, filed on Nov. 3, 2022.

(51) Int. Cl. G06Q 50/18; G06F 40/166; G06F 40/279; G06F 40/40; G06T 11/20

(52) U.S. Cl. CPC G06Q 50/184; G06F 40/166; G06F 40/279; G06F 40/40; G06T 11/206

(57) ABSTRACT

Systems and methods described herein facilitate identification of patenting, commercialization, and/or partnership potential for research institutions by automatically identifying unrealized innovations that would remain hidden within a research institution and to bridge research institutions and companies through data-driven analyses automatically execute previously invisible connections. An artificial intelligence driven analysis engine may leverage natural language processing models to analyze academic publications, grant applications and/or awards, published patent applications, and research interests otherwise published via websites, journals, newspapers, websites, etc. This AI analysis engine then may identify patentable concepts and/or unrealized cooperation opportunities and automatically file a patent application and/or initiate a cooperation agreement.

### CROSS REFERENCE TO RELATED APPLICATION(S)

This application claims priority to Provisional Patent Application No. 63/422,079 entitled “SYSTEMS AND METHODS TO IDENTIFY COMMERCIALIZATION AND PARTNERSHIP POTENTIAL FOR RESEARCH INSTITUTIONS” and filed on Nov. 3, 2022, which is incorporated by reference in its entirety.

### BACKGROUND

Individuals employed in research positions at enterprise organizations (e.g., corporations, research facilities, government laboratories, universities, etc.) may publish research papers detailing aspects of their research interests. In some cases, these papers may be cited during prosecution of unrelated patent applications, thus indicating novel and/or innovative subject matter. In many cases, the authors of these papers fail to recognize the novelty and/or non-obvious aspects of their innovations. Therefore, these authors fail to submit an invention disclosure or file a patent application directed to their research. In such cases, potential opportunities to protect patentable innovations are lost.

It is with these concepts in mind, among others, that various aspects of the present disclosure were conceived.

### BRIEF SUMMARY

The following presents a simplified summary to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different computerized functionality.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes systems and processes for analysis of publications associated with a research organization and/or corresponding to research areas of interest to the research organization.

Aspects of the disclosure relate to computer hardware and software. In particular, one or more aspects of the disclosure generally relate to computer hardware and software for automatically identifying patentable and/or licensable subject matter or concepts that would remain unutilized with former processes and/or automatically executing formal papers to facilitate a licensing agreement and/or automatic patent filing.

Systems and methods described herein facilitate identification of patenting, commercialization, and/or partnership potential for research institutions by automatically identifying unrealized innovations that would remain hidden within a research institution and to bridge research institutions and companies through data-driven analyses automatically execute previously invisible connections. An artificial intelligence driven analysis engine may leverage natural language processing models to analyze academic publications, grant applications and/or awards, published patent applications, and research interests otherwise published via websites, journals, newspapers, websites, etc. This AI analysis engine then may identify patentable concepts and/or unrealized cooperation opportunities and automatically file a patent application and/or initiate a cooperation agreement.

These features, along with many others, are discussed in greater detail below.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. Also, in the drawings the like reference characters refer to the same parts throughout the different views. The drawings depict only typical embodiments of the present disclosure and, therefore, are not to be considered limiting in scope.

FIG. 1 shows illustrative relationships between papers, patents and start-up business activities, according to aspects of the present disclosure;

FIG. 2 shows a visual relationship between paper publications and issued patents, according to aspects of the present disclosure;

FIG. 3 shows charts corresponding to patent-cited papers with respect to gender, tenure status and school, according to aspects of the present disclosure;

FIG. 4 shows a chart identifying a relationship between published papers and unrealized patenting potential, according to aspects of the present disclosure;

FIG. 5A shows a number of authors having papers cited by patents, but without providing an invention disclosure, according to aspects of the present disclosure;

FIG. 5B shows a number of authors having papers cited by patents and with one invention disclosure, according to aspects of the present disclosure;

FIG. 5C shows a number of authors having papers cited by patents and with two invention disclosures, according to aspects of the present disclosure;

FIG. 5D shows a number of authors having papers cited by patents and with three invention disclosures, according to aspects of the present disclosure;

FIGS. 6A-6C show information associated with an author having publications cited in patent prosecution and not having provided an invention disclosure, according to aspects of the present disclosure;

FIGS. 7A-7C show information associated with an author having publications cited in patent prosecution and not having provided an invention disclosure, according to aspects of the present disclosure;

FIGS. 8A-8C show information associated with an author having publications cited in patent prosecution and not having provided an invention disclosure, according to aspects of the present disclosure;

FIGS. 9A-9C show information associated with an author having publications cited in patent prosecution and having provided a single invention disclosure, according to aspects of the present disclosure;

FIGS. 10A-10C show information associated with an author having publications cited in patent prosecution and having provided multiple invention disclosures, according to aspects of the present disclosure; and

FIG. 11 shows a block diagram of an illustrative processor platform structured to execute instructions in accordance with at least one aspect of the disclosure.

### DETAILED DESCRIPTION

Aspects of the present disclosure relate data science, science of science, innovation, evidence-based decision making and, more particularly to identifying inventors and potential opportunities for leveraging innovations. For example, particular aspects of this disclosure relate to a novel software package that helps identify potential inventors in a university or other research-based setting and predict or otherwise suggest potential partnership opportunities with companies or other enterprise organizations; helps enterprise organizations for collaborative relationships with other enterprise organizations (e.g., company collaborate with a university, etc.), search for unique talents and/or technical expertise, and generate benchmarks with respect to other related entities (e.g., competitors, research laboratories, etc.), and predict, such as for investors or for other organizations, forthcoming or potential patent issuance given the identification of papers that have characteristics that might lead to future patents.

In some cases, the systems and methods to identify commercialization and partnership potential for research institutions may aggregate and integrate data from multiple data sources to gain perspective on the use of published research in intellectual property. Using methods applied from the science of science, the systems and methods may identify potential partners for research organizations by identifying those organizations that have cited a research institute's publications in their patents. The systems and methods to identify commercialization and partnership potential for research institutions may include a user-friendly interface that allows a user to (1) understand the scholars and scholarship activities being performed at a given research institution and whose research publications have been cited in another organization's patents, (2) understand a scholars' patents at a given research institution, and (3) based on steps (1) and (2), identify scholars who have papers cited during prosecution of patent applications and/or issued patents, but themselves have few or no patents as the individuals whose ideas and innovations have unrealized commercialization potential, (4) aggregate the companies which are most frequently citing a given research institution's research publications, and (4) offer suggestions about and/or predict which companies may be good research partners based on the quantity of research cited and the importance of the research cited within the patent (e.g., identify opportunities where unrealized patent potential subject matter of written publications are a critical component of one or more issued patents to others). The attached Appendices entitled “Identifying Potential Innovations at Northwestern” (Appendix A) and “Illustrative Licenses of Datasets” (Appendix B) highlight additional examples and details related to at least the structures and methods described herein and are incorporated by reference in their entirety herein.

The systems and methods to identify commercialization and partnership potential for research institutions may be used by academic, or other, research institutions to identify potential research and/or commercialization partners, by patent-holding institutions to identify potential research and/or commercialization partners, by investors (i.e. venture capital, private equity, angel investors, institutional investors, etc.) to identify trends in certain disciplinary fields. For example, the systems and methods to identify commercialization and partnership potential for research institutions may improve upon existing technologies through identification of an empty market space to leverage big data on science and innovation to build tools to help institutions (e.g., technology transfer office in research institutions, company research and development divisions, etc.) to identify unrealized innovations and find hidden connections that might lead to partnerships and/or additional innovations. The systems and methods to identify commercialization and partnership potential for research institutions may be differentiated from other solutions to the problem it addresses because current solutions are mainly based on individual experts' knowledge performed in a manual way and thus lack a systematic and automatic way to identify lost opportunities and predict future development, innovation, partnership, and/or commercial opportunities before the opportunity passes.

As described herein, the systems and methods to identify commercialization and partnership potential for research institutions solves problems for universities as it provides a data-based method to identify potential innovations within the university and commercialization partnerships with the industry. Enterprise organizations that may utilize the systems and methods to identify commercialization and partnership potential of innovations generated by research organizations may include any global research institution, any patent-filing company or company interested in filing patents or otherwise protecting their innovations, and investors in scientific fields (i.e., institutional investors, angel investors, private equity, accelerators, etc.). Such systems and methods are important because interested corporations often fund academic research and/or because patents often lead to revenues via licensing revenue and/or the establishment of startup companies. Further, the systems and methods to identify commercialization and partnership potential for research institutions solves problems for research-dependent companies as it provides a data-based system and method to automatically prioritize research and commercialization partnerships with research institutions. Such activities are important because university partnerships are often based on long-standing relationships as opposed to data driven direction. By utilizing data as evidence, companies can be more strategic and focused in their outreach and investments within academic enterprises. Additionally, for investors and funders, a software-based tool to identify commercialization and partnership potential for research institutions allows the investors and other funders to identify potential collaborations that might advance a certain domain/investment area that may otherwise be lost or go unrecognized. With investments, often the slightest signal or prediction of relevant activities that can be obtained prior to public knowledge gives investors an opportunity that might suggest opportunities ripe (or not) for investment due to important or otherwise relevant innovation activities.

As described herein, a value of the systems and methods to identify commercialization and partnership potential for research institutions manifests itself, for example, in the following ways: (1) identify unrealized innovations in a research institution that would otherwise remain hidden; and (2) bridge research institutions and companies through data-driven analyses and help them make previously invisible connections.

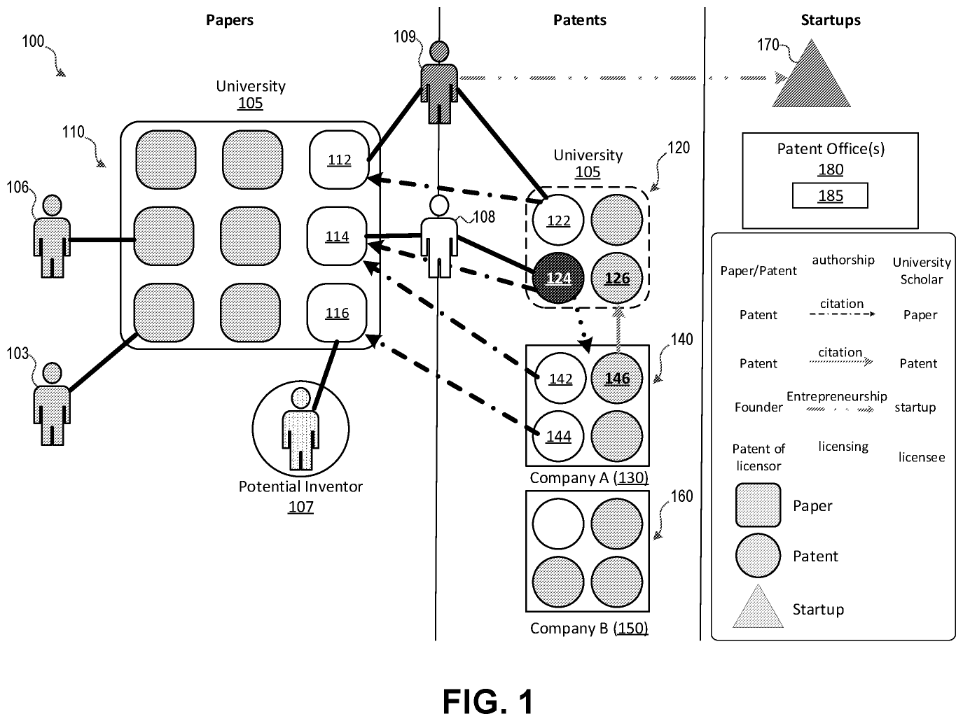

FIG. 1 shows illustrative relationships 100 between papers, patents and start-up business activities, according to aspects of the present disclosure. For example, A research organization (e.g., a university 105) may employ or otherwise have relationships with individuals 103, 106, 107, 108, and 109 engaged in research activities. Results of their research may often be published (e.g., in papers or articles 110) and read by other researchers and/or investors inside or outside the research organization, such as by individuals associated with outside companies and/or investors in technology or otherwise interested in commercialization activities. For example, individual 109 may leverage knowledge gained and/or technical expertise that relates to the research published in paper 112 to form a startup company 170. Patent applications may be filed at one or more patent offices 180 via an electronic interface 185. The electronic interface 185 may further include search and/or publishing capabilities, such that patent information (e.g., filing information, publication information, prosecution history information, and the like) may be electronically received. While some technological innovations published in papers may be protected such as with a filing of a patent application, many other opportunities to protect such innovations are lost. In doing so, other commercialization, partnership, or investment opportunities are likewise lost. For example, individual 107 published a paper 116, which was then cited by patent 144. However, if no patent application was filed by the university, the potential inventor (e.g., individual 107) and the university 105 would lose that opportunity. In some cases, an opportunity for filing a patent may be identified by the systems and methods described herein before any such opportunity is lost.

In the illustrative example shown in FIG. 1, the university 105 may have a relationship with individuals 103, 106, 107, 108, and 109, where results of their research may be published such as in papers or articles 110. The university 105 may have a patent portfolio 120 that may include patents and/or patent applications associated with research activities performed by individuals that are or have been associated with the university. Similarly, companies may also have patent portfolios. For example, company 130 may have one or more patents in their patent portfolio 140 and company 150 may have one or more patents or patent applications in their portfolio 160. As shown, individual 109 is shown to be an author of paper 112 and an inventor of patent application 122, which includes a citation to the paper 112. The paper 112 may disclose the same information sought to be protected in a patent of patent application 122, or may discuss similar or related information. Similarly, individual 108 is shown to be an author of a paper 114 and an inventor of patent 124, which likewise cites the publication (e.g., the paper 114). Licensing opportunities may exist between different organizations to leverage particular expertise to benefit each of the participating organizations. Here, the university 105 has licensed the patent 124 to company 130. Additionally, during prosecution of a patent application, different patents and/or publications may be cited by an examiner or the applicant, as shown with patent 146 having a citation to patent 126, patent 142 citing paper 114, patent 124 citing paper 114, patent 144 citing paper 116, and the like.

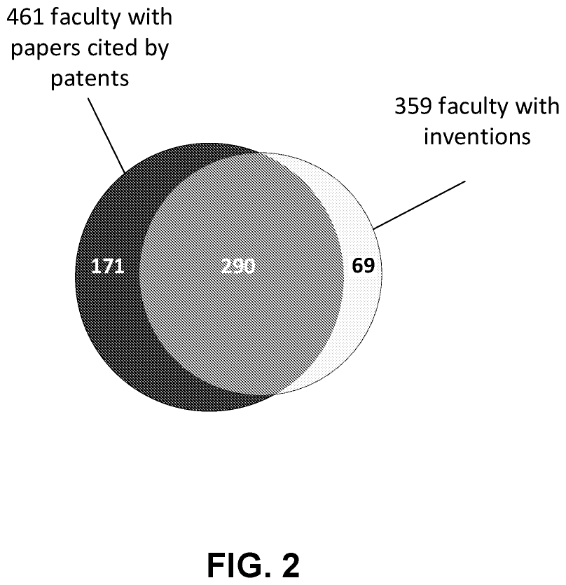

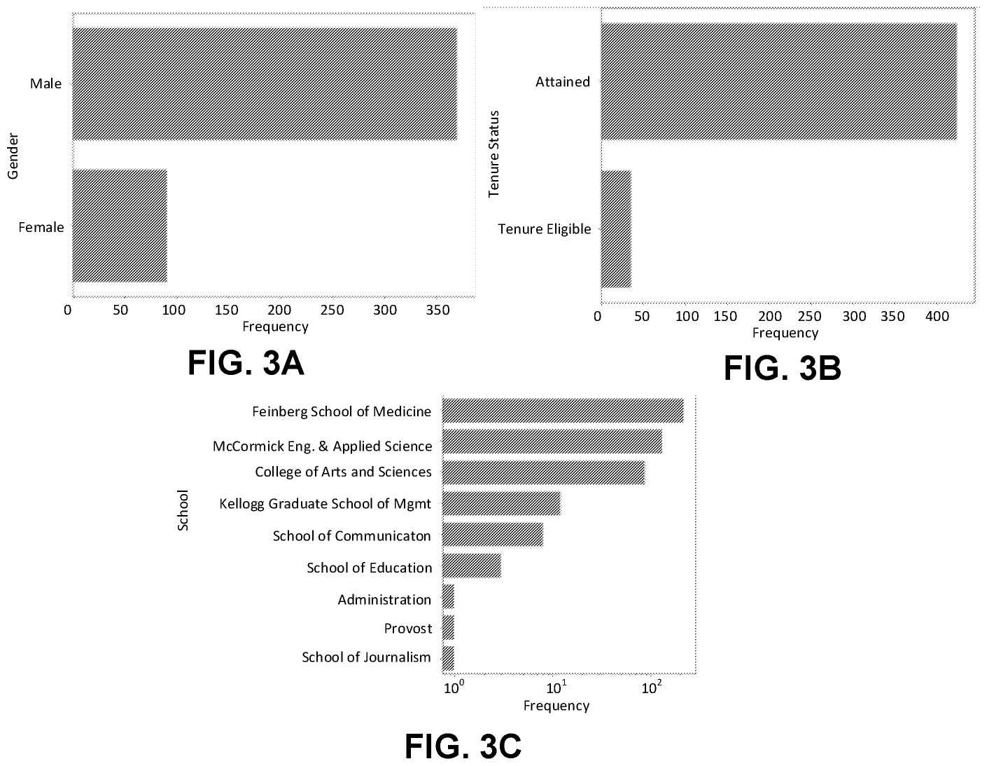

FIG. 2 shows a visual relationship between paper publications and issued patents, according to aspects of the present disclosure. The chart of FIG. 2 illustrates reasons behind identification of the novel method for identifying potential inventors at a research organization. Such an approach may include (1) identification of current individuals performing research activities at a particular research organization, (2) selecting current individuals with patent-cited papers and utilize other state of the art patent-paper citation information, such as data downloaded from public or private patent prosecution data repositories, (3) selecting current individuals with disclosed patentable subject matter using organizational information, and combine the data from steps (1)-(3) to identify or otherwise predict potential inventive activities and/or potential inventors at the research organization. Additionally, FIG. 3 shows charts corresponding to patent-cited papers with respect to gender, tenure status and school, according to aspects of the present disclosure.

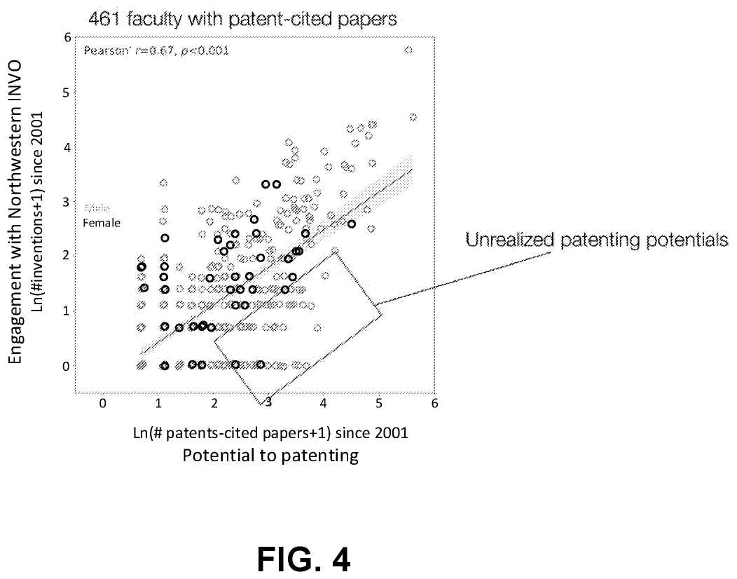

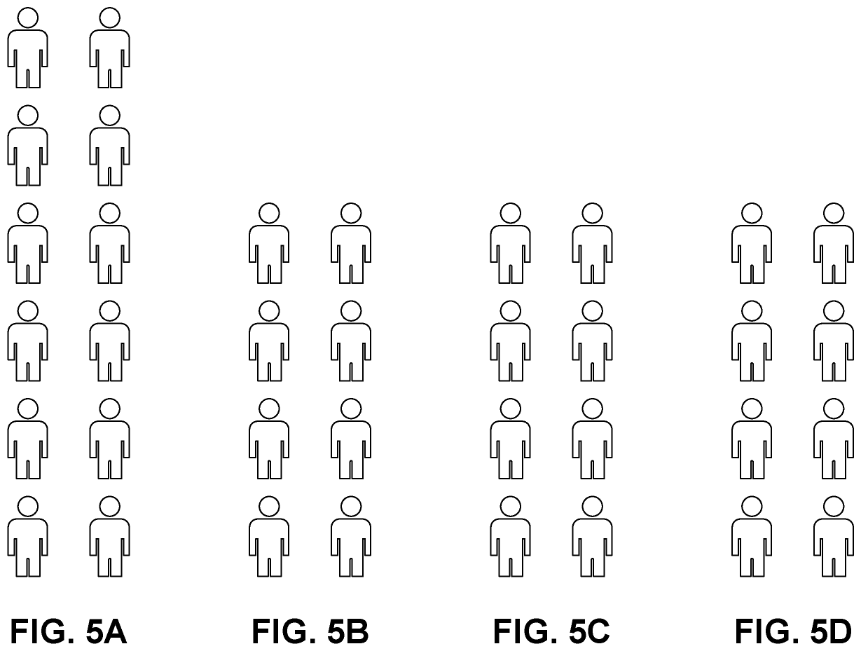

FIG. 4 shows a chart identifying a relationship between published papers and unrealized patenting potential, according to aspects of the present disclosure. For example, the char illustrates that while a large number of individuals employed by a research institution (e.g., faculty at a university) may have published papers, a significant number (e.g., about ⅓) of these individuals have no disclosed inventions based on their research. FIG. 5A shows a number of authors having papers cited by patents, but without providing an invention disclosure, FIG. 5B shows a number of authors having papers cited by patents and with one invention disclosure, FIG. 5C shows a number of authors having papers cited by patents and with two invention disclosures, and FIG. 5D shows a number of authors having papers cited by patents and with three invention disclosures, according to aspects of the present disclosure.

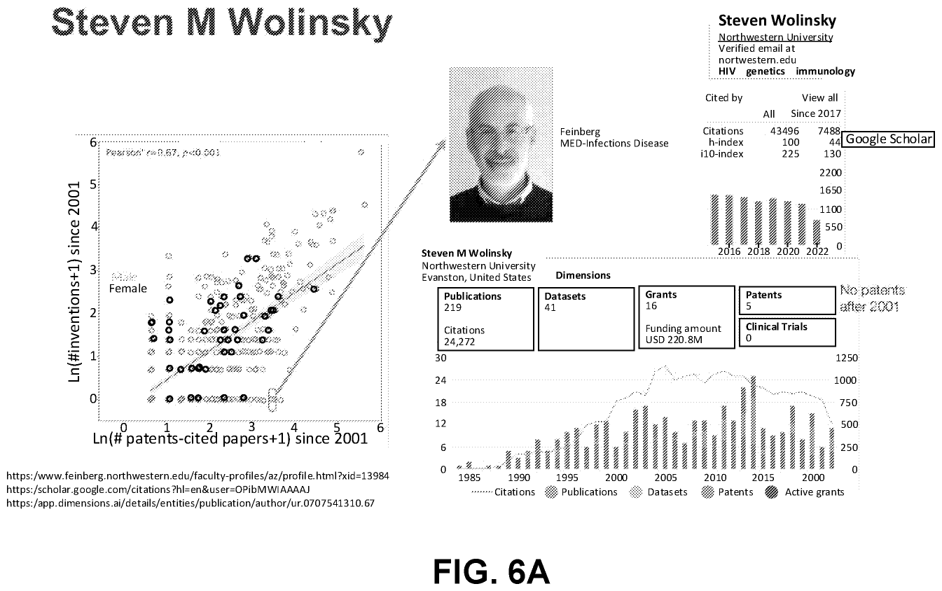

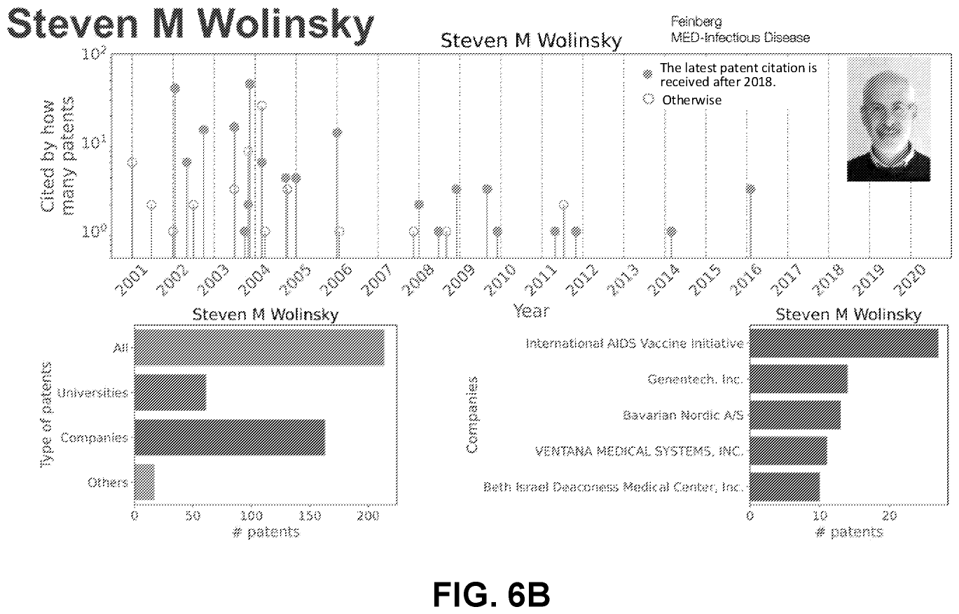

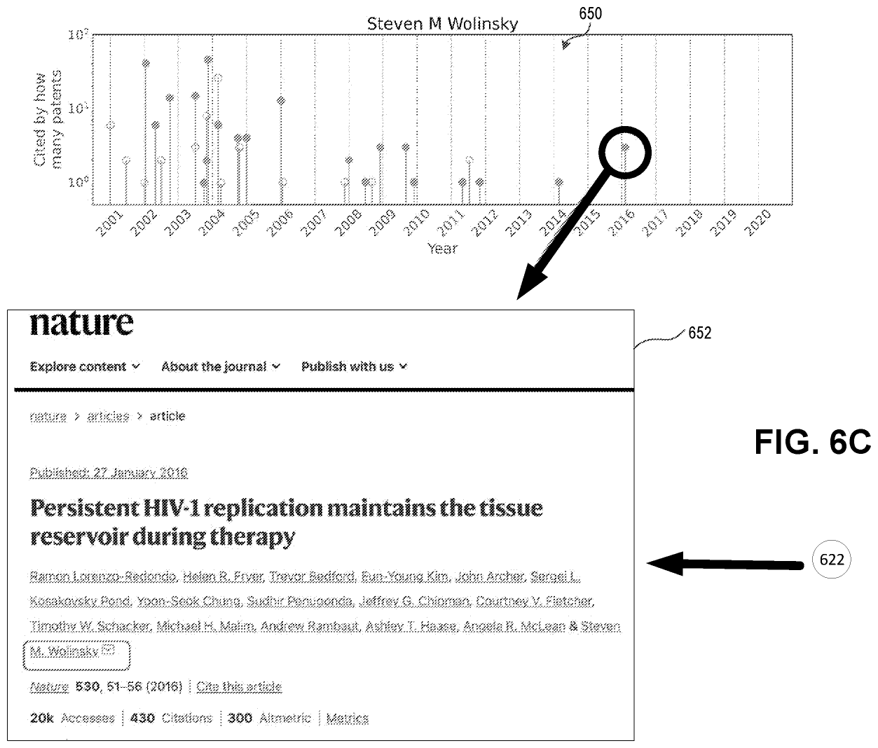

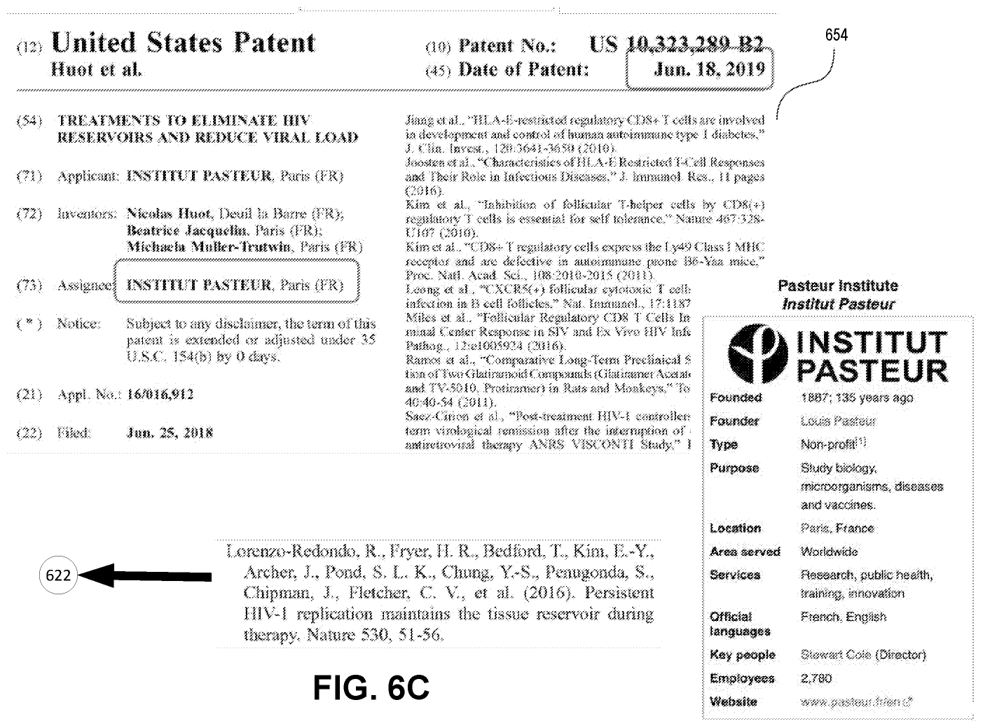

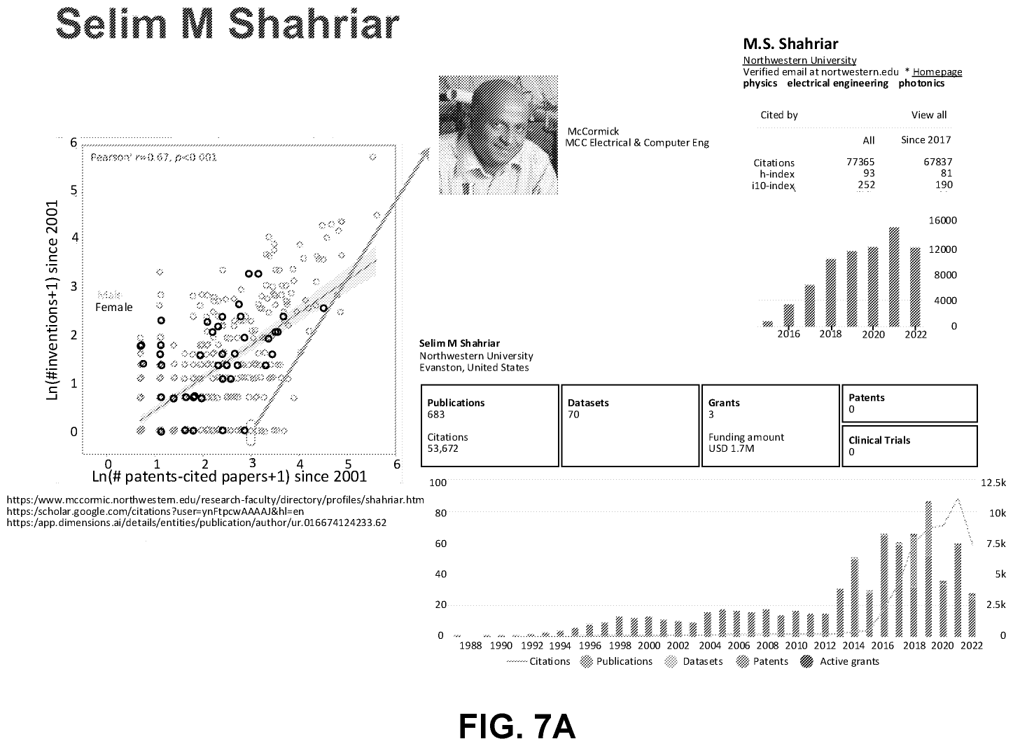

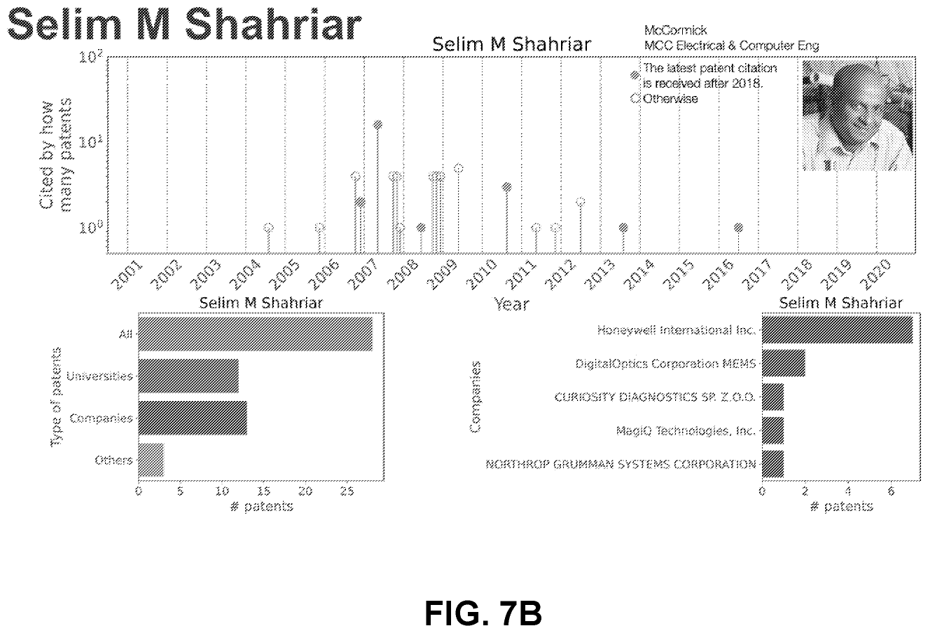

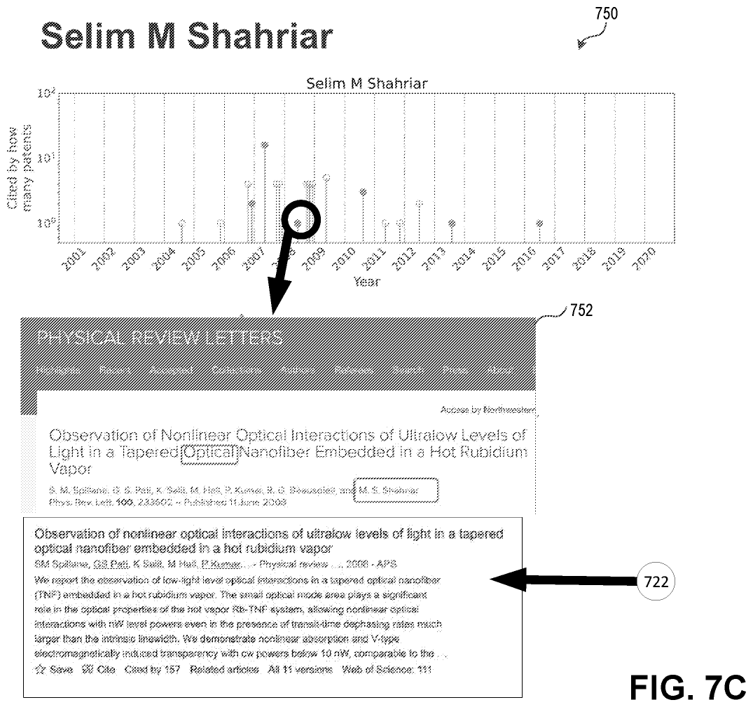

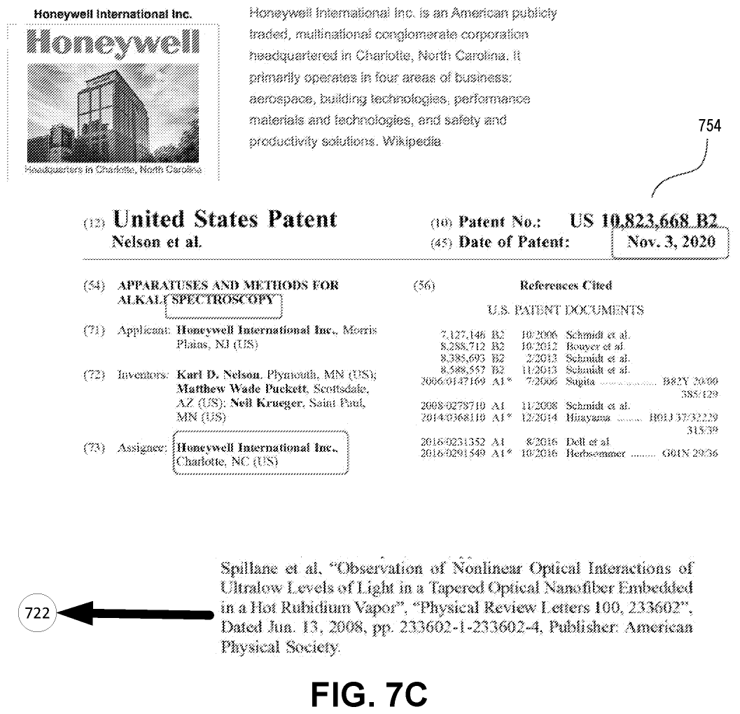

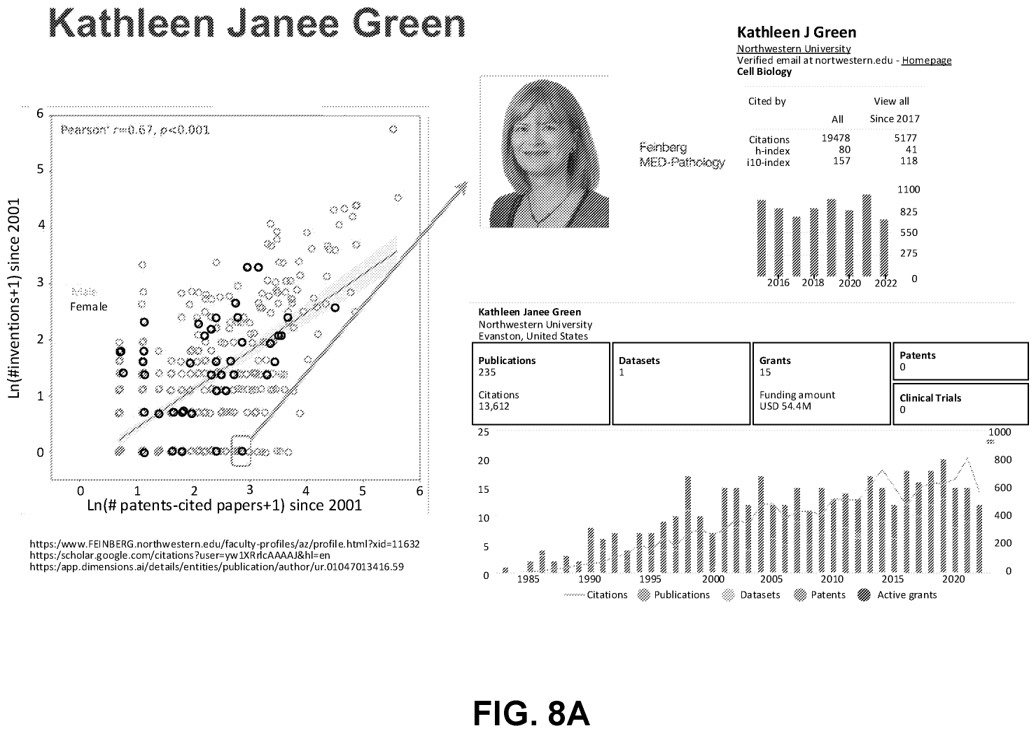

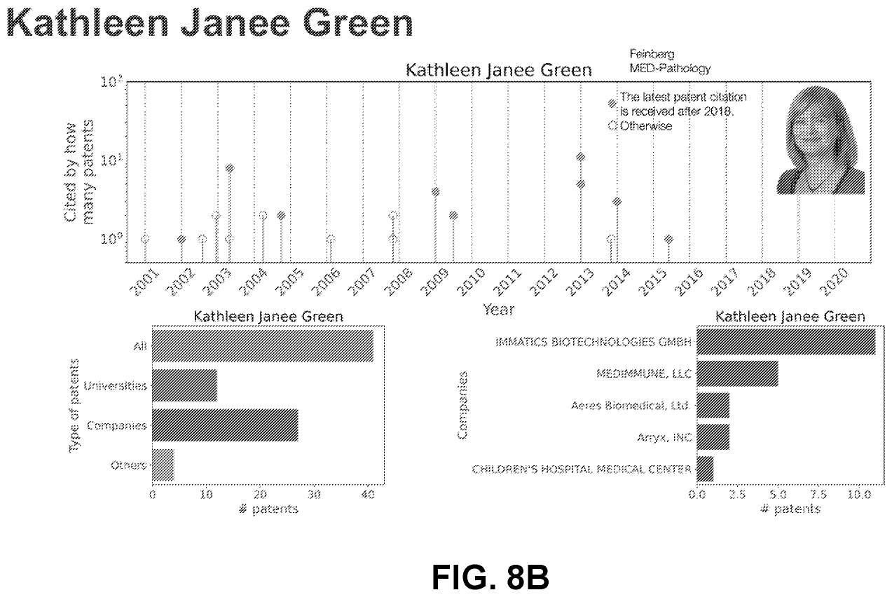

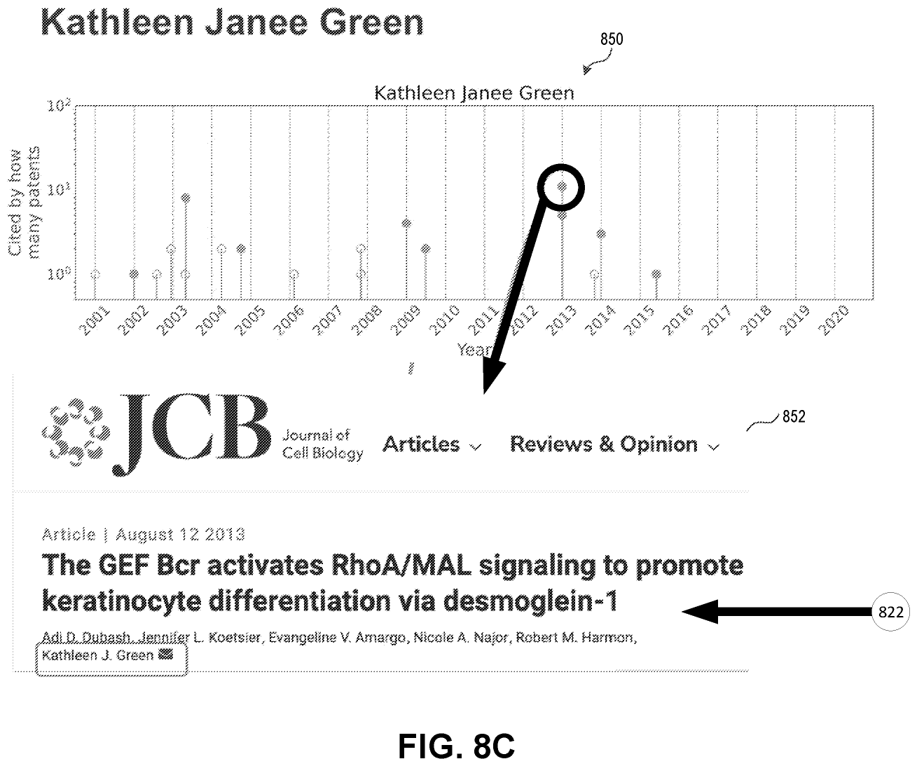

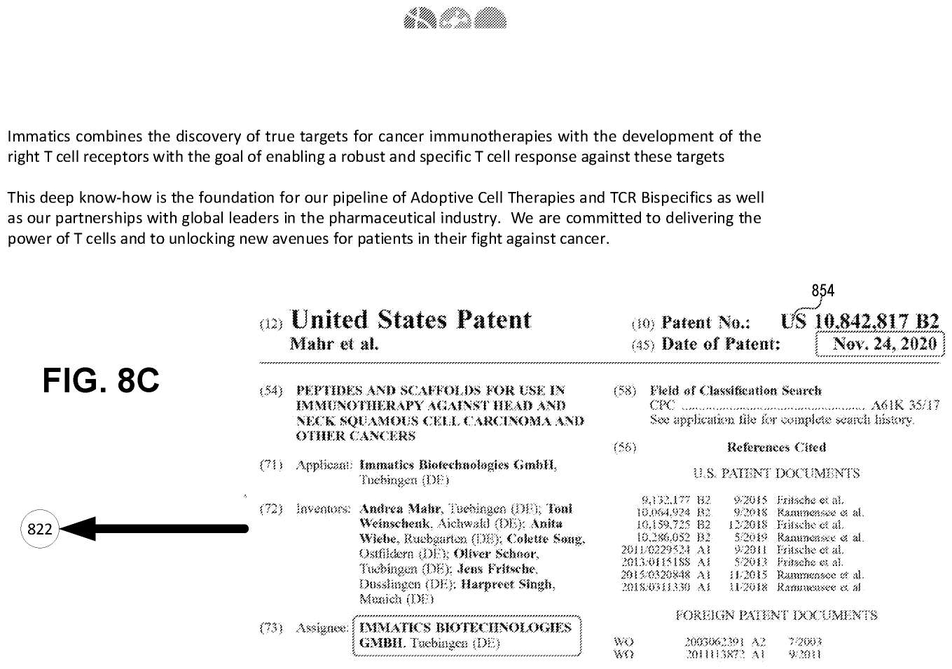

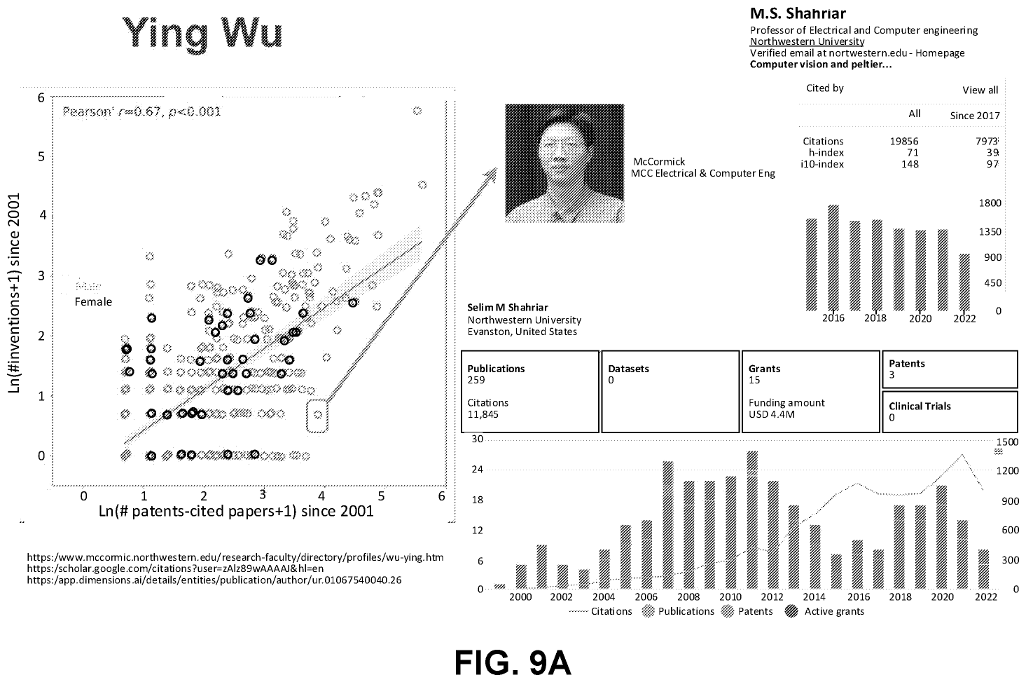

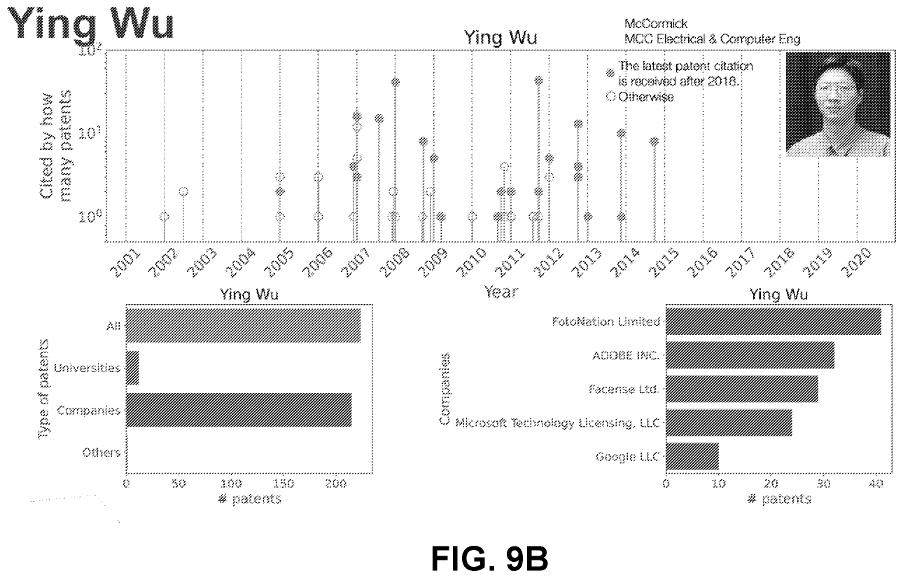

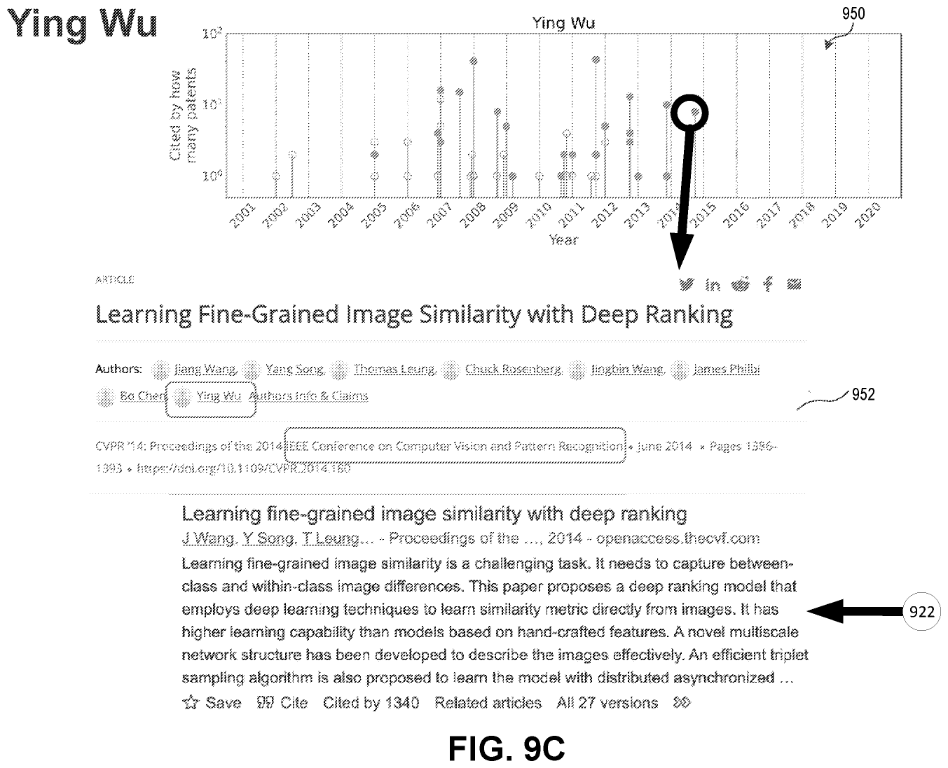

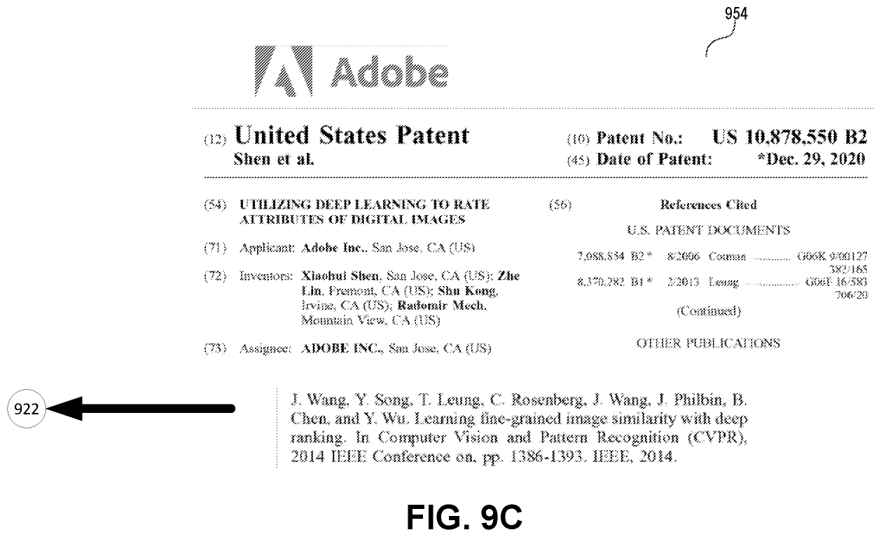

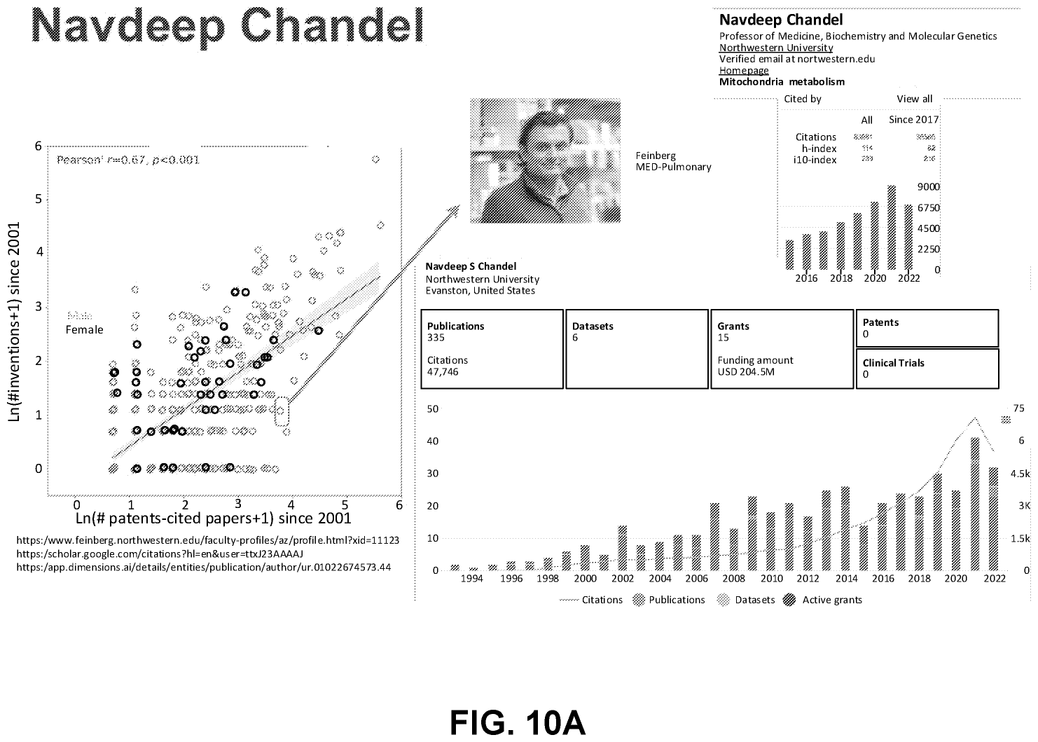

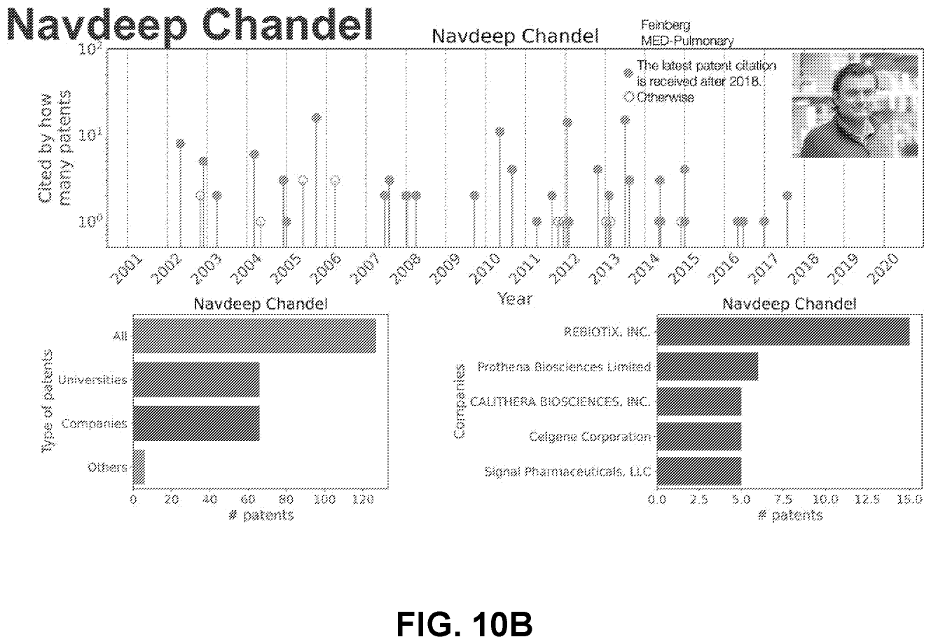

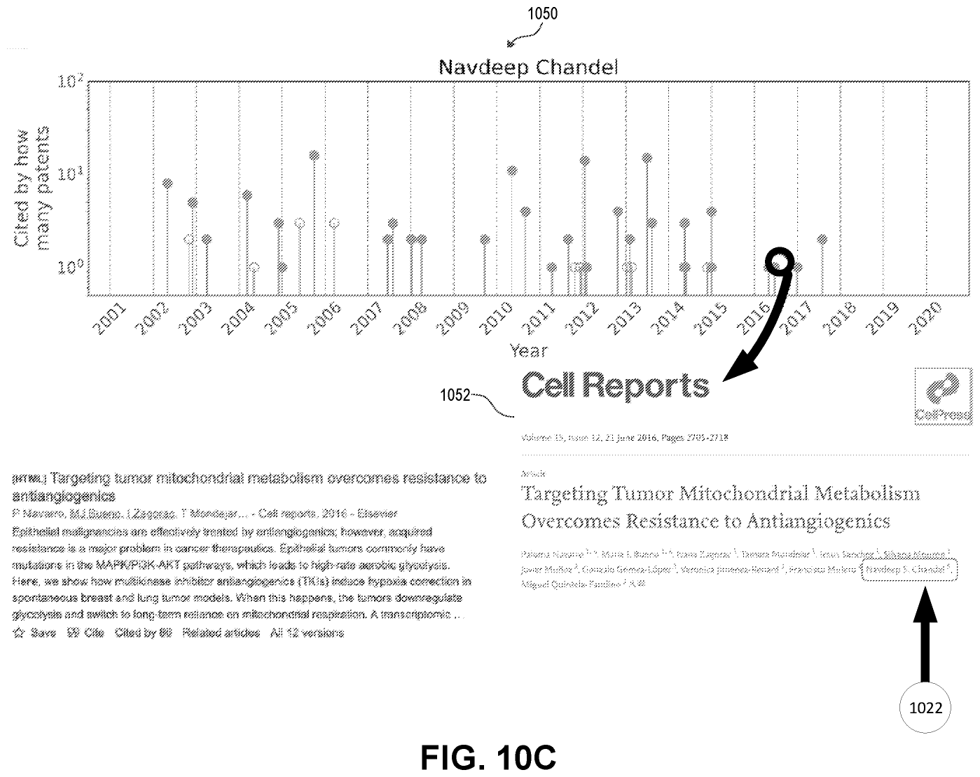

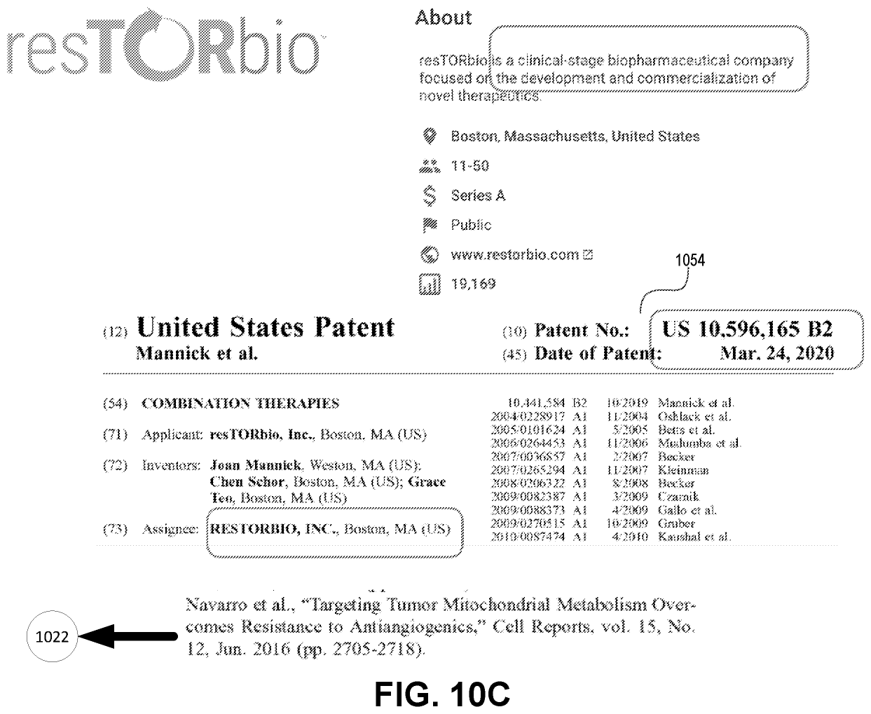

FIGS. 6A-6C, 7A-7C, and 8A-8C show information associated with particular published authors employed by a research organization that has many published papers cited in patent prosecution but have not provided an invention disclosure or have filed a patent application based on their research. FIGS. 9A-9C show information associated with an author having publications cited in patent prosecution and having provided a single invention disclosure, and FIGS. 10A-10C show information associated with an author having publications cited in patent prosecution and having provided multiple invention disclosures. For example, each of FIGS. 6C, 7C, 8C, 9C, and 10C show patent citation charts 650, 750, 850, 950, and 1050 that provide a graphical representation of a number of times a publication 652, 752, 852, 952, and 1052 associated with the particular author has been cited in a patent 654, 754, 854, 954, and 1054.

Information shown in these figures may be used as inputs into a machine learning or artificial intelligence-based system and/or method to identify commercialization and partnership potential for research institutions. For example, information of historical paper publications, patent application filings, issue patents, commercialization and/or license opportunities may be used to train a model executed by the machine learning or artificial intelligence-based system to identify future opportunities and/or to minimize lost opportunities. Feedback, such as in the form of issued patents, commercialization records, and the like may be used to continually train the models to identify future patent or commercialization opportunities based on planned publication of research activities and/or research proposals, grant requests, fellowship applications, and the like. Information may be entered or presented via a web-based interface.

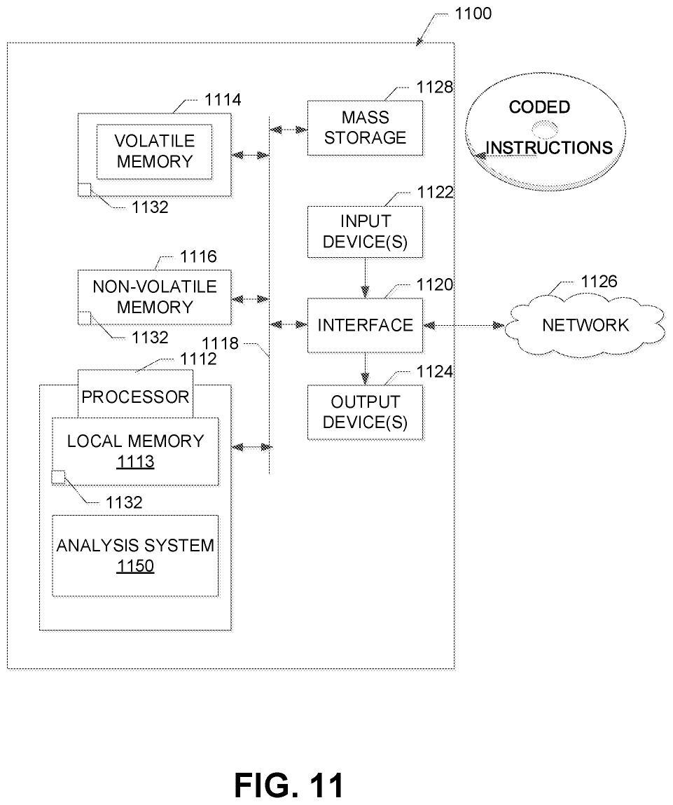

FIG. 11 is a block diagram of an illustrative processor platform 1100 structured to executing instructions to perform actions discussed with reference to FIGS. 1-10C to implement the illustrative components disclosed and described herein with respect to FIGS. 1-10D. The processor platform 1100 can be, for example, a server, a personal computer, a mobile device (e.g., a cell phone, a smart phone, a tablet such as an iPad™), a personal digital assistant (PDA), an Internet appliance, or any other type of computing device.

The processor platform 1100 of the illustrated example includes a processor 1112. The processor 1112 of the illustrated example is hardware. For example, the processor 1112 can be implemented by integrated circuits, logic circuits, microprocessors or controllers from any desired family or manufacturer.

The processor 1112 of the illustrated example includes a local memory 1113 (e.g., a cache). The illustrative processor 1112 of FIG. 11 executes the instructions of at least FIG. 1 to implement the systems and infrastructure and associated methods of FIGS. 1-5D, etc. The processor 1112 of the illustrated example is in communication with a main memory including a volatile memory 1114 and a non-volatile memory 1116 via a bus 1118. The volatile memory 1114 can be implemented by Synchronous Dynamic Random-Access Memory (SDRAM), Dynamic Random-Access Memory (DRAM), RAMBUS Dynamic Random-Access Memory (RDRAM) and/or any other type of random-access memory device. The non-volatile memory 1116 can be implemented by flash memory and/or any other desired type of memory device. Access to the main memory 1114, 1116 is controlled by a clock controller.

The processor platform 1100 of the illustrated example also includes an interface circuit 1120. The interface circuit 1120 can be implemented by any type of interface standard, such as an Ethernet interface, a universal serial bus (USB), and/or a PCI express interface.

In the illustrated example, one or more input devices 1122 are connected to the interface circuit 1120. The input device(s) 1122 permit(s) a user to enter data and commands into the processor 1112. The input device(s) can be implemented by, for example, a sensor, a microphone, a camera (still or video), a keyboard, a button, a mouse, a touchscreen, a track-pad, a trackball, an isopoint device, and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 1120 of the illustrated example, thus, typically includes a graphics driver card, a graphics driver chip, or a graphics driver processor.

The interface circuit 1120 of the illustrated example also includes a communication device such as a transmitter, a receiver, a transceiver, a modem and/or network interface card to facilitate exchange of data with external machines (e.g., computing devices of any kind) via a network 1126 (e.g., an Ethernet connection, a digital subscriber line (DSL), a telephone line, coaxial cable, a cellular telephone system, etc.).

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, RAID systems, and digital versatile disk (DVD) drives.

The coded instructions 1132 of FIG. 11 can be stored in the mass storage device 1128, in the volatile memory 1114, in the non-volatile memory 1116, and/or on a removable tangible computer readable storage medium such as a CD or DVD.

The analysis system 1150 may include a paper intake module, a patent intake module, an artificial intelligence and/or machine learning analysis module, a reporting module, a connection engine and the like. One or more of the paper intake module, the patent intake module, the artificial intelligence and/or machine learning analysis module, the reporting module, and the connection engine may be implemented in hardware, firmware, software, and/or the like, where instructions processes by the processor 1112 may cause the analysis system 1150 to perform actions implementing the paper intake module, the patent intake module, the artificial intelligence and/or machine learning analysis module, the reporting module, and the connection engine. For example, the paper intake module may analyze papers published in a plurality of journals, such as via inputs, a crawler engine automatically accessing each of the plurality of journal publications via a network connection and/or the like. The patent intake module may analyze patent publications, patent application publications via network connections, where an machine learning module may process identify keyworks and/or key-value pairs to identify patents and/or patent applications for connections to published papers, articles, and/or identified research interests of a plurality of authors, professors, researchers, students, where the model may identify a relation score corresponding to a likelihood that papers and/or patents cover related subject matter, where the relation score may be calculated via a weighting function (e.g., a weighted sum of identified papers). In some cases, the weights may be static, or may vary based on whether identical words or phrases are identified versus whether the words or phrases identify a related concept. Such relationships may be learned over time via feedback received from the reporting module or other inputs.

In some cases, the analysis system 1150 may process instructions that cause the analysis system 1150 to perform the steps to automatically identifying innovative technological activities by obtaining information corresponding to pending publication of a plurality of research papers, obtaining information of filed patent-related publications, wherein at least a portion of subject matter of the patent-related publications corresponds to subject matter of at least one pending publication of a research paper, training a machine-learning model based on the information corresponding to pending publication of a plurality of research papers and the information of filed patent-related publications, analyzing, by a machine learning engine based on the trained model, information corresponding to future research publications, and generating, automatically and by the machine learning engine, an invention disclosure form corresponding to at least one future research publication.

In some cases, the analysis system 1150 may also trigger, based on the generation of an invention disclosure form, filing of a patent application. In some cases, analysis system may generate a user input screen and cause the user input screen to be presented at a user device, where information identifying a patentable concept, a licensable concept, and/or the like to be presented to the user. The user interface screen may include an input, that when selected by the user, may cause the analysis system 1150 to perform a plurality of actions associated with the patentable subject matter, the licensable subject matter, and/or the like. The analysis system 1150 may further perform steps including generating, automatically and by the machine learning engine, a presentation and/or an agreement document corresponding to at least one future research publication, wherein training of machine-learning model further includes training based on existing publications of a second plurality of research papers and the information of granted patent publications, linking a first topic of the at least one future publication to a second topic of a patent application and/or generating, based on a link between the first topic and the second topic, a key word link between a first organization associated with the at least one future publication to a second organization associated with the patent application.

In some cases, the analysis system 1150 may perform steps that may include generating, based on the key word link, a report comprising a graphical representation of potential relationships between the first organization and the second organization. The analysis system 1150 may further automatically generate forms, papers, and/or the like, such as patent application text, patent publication figures, patent formal papers, licensing agreements, and/or the like. For example, the analysis system 1150 may perform steps including generating, automatically, patent application text based on an identification of a patentable concept by the machine learning engine, filing, automatically and via an electronic interface of one or more patent offices, the patent application with automatically generated filing papers, automatically generating filing papers based on identification of the patentable concept and communicating the filing papers for execution via an electronic signature service, and/or the like. Similar steps may be performed when generating licensing agreements, or other contractual language to be incorporated into another legal document. In some cases, the analysis engine may generate a provisional patent application, a patent cooperation treaty (PCT) patent application, a utility application, a design application, a utility model application, and/or the like. The analysis system 1150 may electronically file a patent application, automatically with automatically generated formal papers, via an electronic interface 185 of one or more patent offices 180, as shown in FIG. 1.

The machine learning and/or artificial intelligence engine in accordance with aspects described herein may use machine learning models to review patents and/or papers from large corpus and/or a plurality of sources and distill knowledge using science of science methods and artificial intelligence. Network science and machine learning tools for a given topic can be used to find relevant scientific publications, patent publications, patent application publications, research summaries and the like, organize and group publications and other information based on topic similarity and relation to the topic in general, and distill and summarize content to identify connections and/or score possible opportunities for forging relationships between organizations associated with the publications and predict a likelihood of whether a working relationship (e.g., a research opportunity, a patenting opportunity, a licensing opportunity) either between different organizations and/or for individuals associated with a searching organization, such as a university.

Advances in the area of natural language processing (NLP), have dramatically improved seq2seq and machine translation tasks. Many models are based on bidirectional encoder representations from transformers (BERT) architecture and the have been successfully used for text summarization tasks—an important component integrated with the AI-based knowledge distillation and paper production computing system functionality. For example, BERT comprises a transformer language model having a variable number of encoder layers and self-attention heads. Additionally, BERT models may be pretrained on two tasks: language modelling and next sentence prediction, where the BERT model may be trained to predict a probability that a next sentence given a previous sentence.

The use of transformer-based models, such as those managed by the modeling engine 235, in various natural language processing (NLP) tasks can outperform existing use of recurrent neural networks (RNN) in existing methods. Key components of this differentiation include, but are not limited to, training a RF-IDF algorithm with abstracts of a review and all co-cited papers after lemmatization and grouping papers into sections and considering a variety of ordering structures (i.e. variance-based ordering, degree centrality and other rankings) as well as order of papers within sections.

It should be readily apparent to one having ordinary skill in the art that a variety of machine learning models can be utilized including (but not limited to) decision trees, k-nearest neighbors, support vector machines (SVM), neural networks (NN), recurrent neural networks (RNN), convolutional neural networks (CNN), probabilistic neural networks (PNN), and transformer-based architectures. RNNs can further include (but are not limited to) fully recurrent networks, Hopfield networks, Boltzmann machines, self-organizing maps, learning vector quantization, simple recurrent networks, echo state networks, long short-term memory networks, bi-directional RNNs, hierarchical RNNs, stochastic neural networks, and/or genetic scale RNNs. In a number of embodiments, a combination of machine learning models can be utilized, more specific machine learning models when available, and general machine learning models at other times can further increase the accuracy of predictions.

The reporting engine may generate reports associated with particular individuals, such as a summary of associated articles, datasets, patent publications, patent application publications, citations of articles and/or patents in other publications, active grants associated with research being performed and/or possible extensions of that research. The reporting engine may provide information in a format similar to those shown in FIGS. 6A-10C. The connection engine may automatically determine similarities between different organizations, such as by processing the reporting information by an artificial intelligence engine, where the model may identify key words, and/or key-value pairs and form connections between related key words and/or key-value pairs, based on a scoring module. In some cases, the connection engine may include a prediction module that may identify a likelihood that organizations may be interested in collaboration, licensing activities, or the like. In some cases, the prediction model may output a predicted collaboration score, such as by weighting successful and/or unsuccessful joint research, collaboration, and/or licensing activities and an identified closeness core corresponding to how well the key value pairs match between current research, patent, and/or publishing activities.

From the foregoing, it will be appreciated that the above disclosed methods, apparatus, and articles of manufacture have been disclosed to improve the functioning of a computer and/or computing device and its interaction with data storage and/or data analysis systems.

Thus, certain examples determine categorizations and leverage those calculations to help determine relationships between research activities and/or interests, expertise for particular subject matter, and the like. A combination of analysis of research activities and interests with patent citations and/or grant information enables categorization of papers, patents, and research interests. Predictions on a likelihood of success of a joint research activity and/or patent filing may trigger a patent filing process and/or a joint research activity. Similarly, licensing opportunities may be automatically leveraged by identifying subject matter representative of a licensing opportunity, automatically generating licensing agreement, or licensing language to be automatically incorporated of a legal document (e.g., a patent assignment, a contract, a non-disclosure agreement, etc.), automatically sending an automatically generated legal document for electronic signature to relevant parties, and/or automatically recording, if applicable, the executed legal document.

One or more aspects discussed herein can be embodied in computer-usable or readable data and/or computer-executable instructions, such as in one or more program modules, executed by one or more computers or other devices as described herein. Generally, program modules include routines, programs, objects, components, data structures, and the like. that perform particular tasks or implement particular abstract data types when executed by a processor in a computer or other device. The modules can be written in a source code programming language that is subsequently compiled for execution, or can be written in a scripting language such as (but not limited to) HTML or XML. The computer executable instructions can be stored on a computer readable medium such as a hard disk, optical disk, removable storage media, solid-state memory, RAM, and the like. As will be appreciated by one of skill in the art, the functionality of the program modules can be combined or distributed as desired in various embodiments. In addition, the functionality can be embodied in whole or in part in firmware or hardware equivalents such as integrated circuits, field programmable gate arrays (FPGA), and the like. Particular data structures can be used to more effectively implement one or more aspects discussed herein, and such data structures are contemplated within the scope of computer executable instructions and computer-usable data described herein. Various aspects discussed herein can be embodied as a method, a computing device, a system, and/or a computer program product.

Although the present invention has been described in certain specific aspects, many additional modifications and variations would be apparent to those skilled in the art. In particular, any of the various processes described above can be performed in alternative sequences and/or in parallel (on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method of automatically identifying innovative technological activities comprising:
obtaining information corresponding to pending publication of a plurality of research papers;
obtaining information of filed patent-related publications, wherein at least a portion of subject matter of the patent-related publications corresponds to subject matter of at least one pending publication of a research paper;
training a machine-learning model based on the information corresponding to pending publication of a plurality of research papers and the information of filed patent-related publications;
analyzing, by a machine learning engine based on the trained model, information corresponding to future research publications; and
generating, automatically and by the machine learning engine, a disclosure form corresponding to at least one future research publication.

2. The method of claim 1, further comprising triggering, based on the generation of the disclosure form, filing of a patent application.

3. The method of claim 1, further comprising generating, automatically and by the machine learning engine, a presentation and/or an agreement document corresponding to at least one future research publication.

4. The method of claim 1, wherein training of machine-learning model further includes training based on existing publications of a second plurality of research papers and the information of granted patent publications.

5. The method of claim 1, comprising:
linking a first topic of the at least one future publication to a second topic of a patent application; and
generating, based on a link between the first topic and the second topic, a key word link between a first organization associated with the at least one future publication to a second organization associated with the patent application.

6. The method of claim 5 further comprising generating, based on the key word link, a report comprising a graphical representation of potential relationships between the first organization and the second organization.

7. The method of claim 1, further comprising generating, automatically, patent application text based on an identification of a patentable concept by the machine learning engine.

8. The method of claim 7, further comprising filing, automatically and via an electronic interface of one or more patent offices, the patent application with automatically generated filing papers.

9. The method of claim 7, further comprising automatically generating filing papers based on identification of the patentable concept and communicating the filing papers for execution via an electronic signature service.

10. The method of claim 7, wherein the patent application comprises a provisional patent application.

11. A computing device to automatically identify innovative technological activities comprising:
a processor;
non-transitory memory storing instructions that cause, when executed by the processor, the computing device to:
obtain information corresponding to pending publication of a plurality of research papers;
obtain information of filed patent-related publications, wherein at least a portion of subject matter of the patent-related publications corresponds to subject matter of at least one pending publication of a research paper;
train a machine-learning model based on the information corresponding to pending publication of a plurality of research papers and the information of filed patent-related publications;
analyze, by a machine learning engine based on the trained model, information corresponding to future research publications; and
generate, automatically and by the machine learning engine, a disclosure form corresponding to at least one future research publication.

12. The computing device of claim 11, wherein the instructions further cause the computing device to trigger, based on the generation of the disclosure form, filing of a patent application.

13. The computing device of claim 11, wherein the instructions further cause the computing device to generate, automatically and by the machine learning engine, a presentation and/or an agreement document corresponding to at least one future research publication.

14. The computing device of claim 11, wherein training of machine-learning model further includes training based on existing publications of a second plurality of research papers and the information of granted patent publications.

15. The computing device of claim 11, wherein the instructions further cause the computing device to link a first topic of the at least one future publication to a second topic of a patent application; and
generate, based on a link between the first topic and the second topic, a key word link between a first organization associated with the at least one future publication to a second organization associated with the patent application.

16. The computing device of claim 15 wherein the instructions further cause the computing device to generate, based on the key word link, a report comprising a graphical representation of potential relationships between the first organization and the second organization.

17. The computing device of claim 11, wherein the instructions further cause the computing device to generate, automatically, patent application text based on an identification of a patentable concept by the machine learning engine.

18. The computing device of claim 17, wherein the instructions further cause the computing device to file, automatically and via an electronic interface of one or more patent offices, the patent application with automatically generated filing papers.

19. The computing device of claim 17, wherein the instructions further cause the computing device to automatically generate filing papers based on identification of the patentable concept and communicating the filing papers for execution via an electronic signature service.

20. The computing device of claim 17, wherein the patent application comprises a provisional patent application.
